(19) United States
(12) Patent Application Publication
(10) Pub. No.: US 2006/0035122 A1
(43) Pub. Date: Feb. 16, 2006

(54) Method for cooling oxygen sensitive components

(76) Inventors: Jeffrey G. Weissman, Broken Arrow, OK (US); Diane M. England, Bloomfield, NY (US)

Correspondence Address: JIMMY L. FUNKE;DELPHI TECHNOLOGIES, INC., Legal Staff, Mail Code: 480-410-202, P.O. Box 5052, Troy, MI, 48007-5052, US

(21) Appl. No.: 10/917,736

(22) Filed: Aug. 13, 2004

(51) Int. Cl. H01M 8/04; H01M 8/06

(52) U.S. Cl. 429/26; 429/19; 429/25; 429/13

(57) ABSTRACT

A system and method for cooling oxygen sensitive components in a fuel cell system comprising supplying air to an air purification device during cool down of a fuel cell system comprising at least one fuel cell comprising an anode, a cathode, and an electrolyte disposed between the anode and cathode; treating the air within the air purification device to produce a flow of nitrogen gas and a waste stream comprising oxygen enriched air; directing a flow of the nitrogen gas through the anode; the anode being in fluid communication with the air purification device and isolated from the fuel reformer and anode exhaust during cool down; the flow of nitrogen gas being directed through the anode in an amount sufficient to balance pressure within the fuel cell cathode and anode during cool down.

### TECHNICAL FIELD

The invention relates generally to fuel cell systems and more particularly relates to a system and method for cooling oxygen sensitive components in a fuel cell stack so as to protect anode stack material or other heated components of a combined fuel processor and stack assembly during cool down.

### BACKGROUND OF THE INVENTION

Referring to FIG. 1, a block diagram of a solid oxide fuel cell system (SOFC) system 10 is shown during normal hot operation including a fuel reformer 12 for supplying an anode fuel stream 14 comprising CO, H₂, N₂, etc., to an SOFC stack 16. Stack 16 is shown for illustrative purposes as comprising a single cell 18. Typically, multiple fuel cells 18 are stacked in series with the anode of one cell being electrically connected to the cathode of the next cell to generate larger potential differences between one end of the stack and the other end of the stack.

As with fuel cells generally, very hot solid oxide fuel cells having high electrical conductivity, are used to convert chemical potential energy in reactant gases into electrical energy. In the solid oxide fuel cell 18, two porous electrodes, anode 20, typically nickel based, and cathode 22, are bonded to an oxide ceramic electrolyte 24 (typically, yttria stabilized zirconia, ZrO₂—Y₂O₃) disposed between them to form a selectively ionic permeable barrier. Molecular reactants cannot pass through the barrier 24, but oxygen ions (O²⁻) diffuse through the solid oxide lattice as indicated by arrow 26. The electrodes 20, 22 are typically formed of electrically conductive metallic or semi conducting ceramic powders, plates or sheets that are porous to fuel and oxygen molecules. Manifolds (not shown) are employed to supply the fuel stream 14 (typically hydrogen, carbon monoxide, nitrogen, or simple hydrocarbon) to the anode 20 and oxygen-containing gas, typically air, 28 to the cathode. The system 10 utilizes an oxygen source such as air compressor 30 to supply the oxygen containing gas 28. The fuel 14 at the anode catalyst/electrolyte interface 32 forms cations that react with oxygen ions diffusing through the solid oxide electrolyte 24 to the anode 20. The oxygen-containing gas 28 (typically air) supplied to the cathode layer 22 converts oxygen molecules into oxygen ions at the cathode/electrolyte interface 34. The oxygen ions formed at the cathode 22 diffuse, combining with the cations to generate a usable electric current 35 and an oxygen depleted air stream 36 (oxygen depleted air stream comprising, for example, about 10% to about 15% oxygen) that is removed from the cell 18 such as through a device 38, which may comprise a combustor or waste heat recovery device 38, or a combination thereof, and exits the system 10 as effluent stream 40. Anode waste stream 44 may be directed through fuel reformer 12 for exhaust gas recycle or to combustor 38 for waste heat recovery.

In transportation applications, solid oxide fuel cell power generation systems are expected to provide a higher level of efficiency than conventional power generators which employ heat engines such as gas turbines and diesel engines that are subject to Carnot cycle efficiency limits. Therefore, use of SOFC systems as power generators in vehicle applications is expected to contribute to efficient utilization of resources and to a relative decrease in the level of CO₂ emissions and an extremely low level of NOx emissions. However, SOFC systems suitable for use in transportation applications require a very compact size as well as efficient thermal management. Thermal management must be accomplished whereby the outer surface of the fuel cell envelope is typically maintained below 45° C. while the temperature inside the stack is about 700° C. to about 950° C. Importantly, normal, hot operation and stack management during cool down and shut down must be accomplished without adverse effect on stack and system components.

The reactions in the fuel cells 18 generate heat. To maintain the fuel cell stack 16 at a desired operating temperature, a cooling system is used to remove the generated heat from the fuel cell. SOFC fuel stacks typically operate in the relatively high temperature range of about 700° C. to about 950° C. Reactant gases are pre-heated, typically by heat exchangers, to prevent the gases from cooling the stack below the optimum operating temperature. During operation, the SOFC stack anode and cathode are isostatic, the stack anode 20 residing in a reducing, oxygen free atmosphere.

During normal hot operation, the cathode 22 is open to the atmosphere via exhaust tubing (not shown). The anode 20 may also be open to the atmosphere via exhaust tubing. Turning to FIG. 2, a block diagram of the system 10 is illustrated during shut down with the letter X indicating interrupted flow (stoppage) of gas streams 14, 28, 44. During shut down, as the stack 16 cools, air will enter the cathode 22 via reverse flow through the exhaust tubing. As the gas cools, the volume decreases and so air is drawn in to maintain atmospheric pressure. Reverse flow comprises air drawn into the cell via natural convection, as make up air.

Nickel based anodes of solid oxide fuel cells are subject to re-oxidation if they are exposed to air at temperatures above about 400° C. to about 500° C. This re-oxidation of the nickel anodes causes degradation of the fuel cell performance.

It is desirable, therefore, to prevent the anode 20 from being exposed to air until the SOFC temperature is less than about 500° C. to prevent oxidative damage to the anode 20. However, if there is no gas flow into the anode 20, the pressure difference builds between the anode 20 and cathode 22, causing damage to the cells 18 via cracking of the electrolyte 24 leading to degradation of the fuel cell.

U.S. Published Patent Application 20030012986 discloses a system for simplifying cooling of a fuel cell system which may be a single cell (1), a stack (15) or a similar configuration and which comprises at least one active membrane (2) sandwiched between an anode layer (4) and a cathode layer (3) and comprising a catalyst, a fuel supply having access to the anode layer and an air supply (17, 18) having access to the cathode layer, while at the same time keeping the effectiveness of the system with reference to energy conversion, volume and weight favorable, the fuel cell system is to be operated such that the air which is supplied by the air supply, is introduced by pressure into the fuel cell system, passes along the cathode layer and then leaves the fuel cell system, is used for both oxidant and coolant. For this purpose, the air is introduced into the fuel cell system (1, 15) with a rate resulting in a stoichiometric rate in the range between 25 and 140.

U.S. Published Patent Application 20020142201 discloses a fuel cell system including a first reactant intake manifold, a first reactant output manifold, a second reactant intake manifold, a second reactant output manifold, a cooling gas intake manifold, a cooling gas output manifold, a liquid intake manifold, fuel cells and cooling elements distributed among the fuel cells. Each cooling element defines a coolant passage. During operation, a cooling gas flows from the cooling gas intake manifold into the cooling gas output manifold through the coolant passage. Each cooling element also includes a water injection path. During operation water from the liquid intake manifold is injected into the coolant passage to mix with the cooling gas passing there through.

U.S. Published Patent Application 20020098394 discloses a process and system for providing a hydrogen-containing gas stream to a fuel cell anode that includes providing a hydrogen-containing gas stream that includes carbon monoxide, introducing the hydrogen-containing gas stream into a pressure swing adsorption module that includes at least one carbon monoxide-selective adsorbent to produce a purified hydrogen-containing gas stream, and introducing the purified hydrogen-containing gas stream to the fuel cell anode. The pressure swing adsorption module can also include a second adsorbent and/or catalyst. Also disclosed is a fuel cell system coupled to an internal combustion engine and a fuel cell system that utilizes fuel cell waste heat for vaporizing a hydrocarbon/water mixture.

U.S. Pat. No. 6,106,963 discloses a fuel cell system 20 equipped with an oxygen enrichment unit 34 and supplies air whose oxygen particle pressure has been increased by the oxygen enrichment unit 34 to fuel cells 40 as oxidizing gas. The oxygen enrichment unit 34 is a magnetic oxygen enrichment device that effects oxygen enrichment utilizing the fact that the oxygen molecule is paramagnetic and when magnetized migrates toward a magnet tic pole side.

U.S. Pat. No. 4,407,904 discloses a fuel cell comprising unit cells stacked through separators there between; each unit cell comprising a fuel electrode plate, an oxidizing agent electrode plate and a matrix between the electrode plate and the oxidizing agent plates, U-shaped gas flow passages for the fuel electrode and for the oxidizing agent electrode are provided in a counter-current relation to each other with gas inlets and gas outlets for the fuel electrode and the gas inlets and the gas outlets for the oxidizing agent electrodes being provided at the opposite sides of the fuel cell, respectively, and communicated respectively with manifolds at the same opposite side of the fuel cell.

The disclosures of the foregoing are incorporated herein by reference in their entireties.

What is needed in the art is an improved system and method for cooling oxygen sensitive components in a fuel cell stack so as to protect anode stack material or other heated components of a combined fuel processor and stack assembly during cool down.

### SUMMARY OF THE INVENTION

A fuel cell system for cooling oxygen sensitive components comprises a fuel cell stack comprising at least one fuel cell comprising an anode, a cathode, and an electrolyte disposed between the anode and cathode;

a fuel reformer disposed in fluid communication with the fuel cell stack for supplying a flow of fuel to the anode;

an air supply disposed in fluid communication with the fuel cell stack for supplying a flow of air to the cathode; and

an air purification device for preparing a nitrogen gas stream, the air purification device having an inlet for receiving a flow of air and an outlet in fluid communication with the fuel cell stack anode for discharging the nitrogen gas stream; a means for supplying a flow of the nitrogen gas stream to the anode during fuel cell cool down and optionally, during fuel cell shut down; and an outlet for discharging a flow of oxygen enriched air;

wherein the flow of the nitrogen gas stream is sufficient to balance pressure within the fuel cell cathode and anode during cool down.

A method for cooling oxygen sensitive components in a fuel cell system comprises:

supplying air to an air purification device during cool down of a fuel cell system comprising at least one fuel cell comprising an anode, a cathode, and an electrolyte disposed between the anode and the cathode;

treating the supplied air within the air purification device to produce a nitrogen gas stream and a waste stream comprising oxygen enriched air;

directing the produced nitrogen gas stream through the anode; the anode being in fluid communication with the air purification device;

the flow of nitrogen gas being sufficient to balance pressure within the fuel cell cathode and anode during fuel cell cool down.

These and other features and advantages of the invention will be more fully understood from the following description of certain specific embodiments of the invention taken together with the accompanying drawings.

### BRIEF DESCRIPTION OF THE DRAWINGS

Referring now to the drawings, which are meant to be exemplary, not limiting, and wherein like elements are numbered alike in the several Figures:

FIG. 1 is a block diagram depicting a fuel cell system and gas flow therein during normal hot operation.

FIG. 2 is a block diagram depicting a fuel cell system and gas flow therein during typical shut down.

FIG. 3 is a block diagram depicting a fuel cell system and gas flow therein during shut down in accordance with the invention.

FIG. 4 is a diagram illustrating an alternate embodiment of the system of FIG. 3 wherein the air separation device comprises a membrane separator.

FIG. 5 is a diagram illustrating another embodiment of the system of FIG. 3 wherein the air separation device comprises a molecular sieve.

FIG. 6 is a diagram illustrating yet another embodiment of the system of FIG. 3 wherein the air purification device comprises a pressure swing adsorption device.

FIG. 7 is a block diagram illustrating a preferred embodiment of the invention comprising the system of FIG. 3 disposed in an engine system employing enriched air produced by the air purification device, which can operate continuously without need for regeneration.

FIG. 8 is a block diagram illustrating an alternate embodiment of the fuel cell system of FIG. 3 including an oxygen removal device disposed between the air purification device and the anode.

### DESCRIPTION OF THE PREFERRED EMBODIMENT

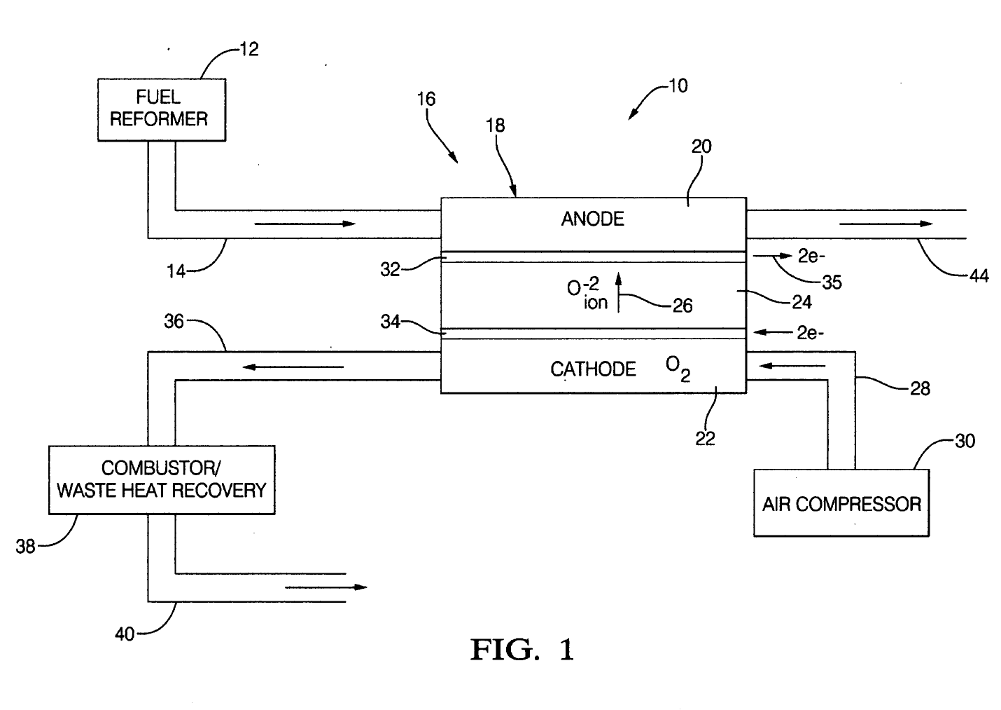

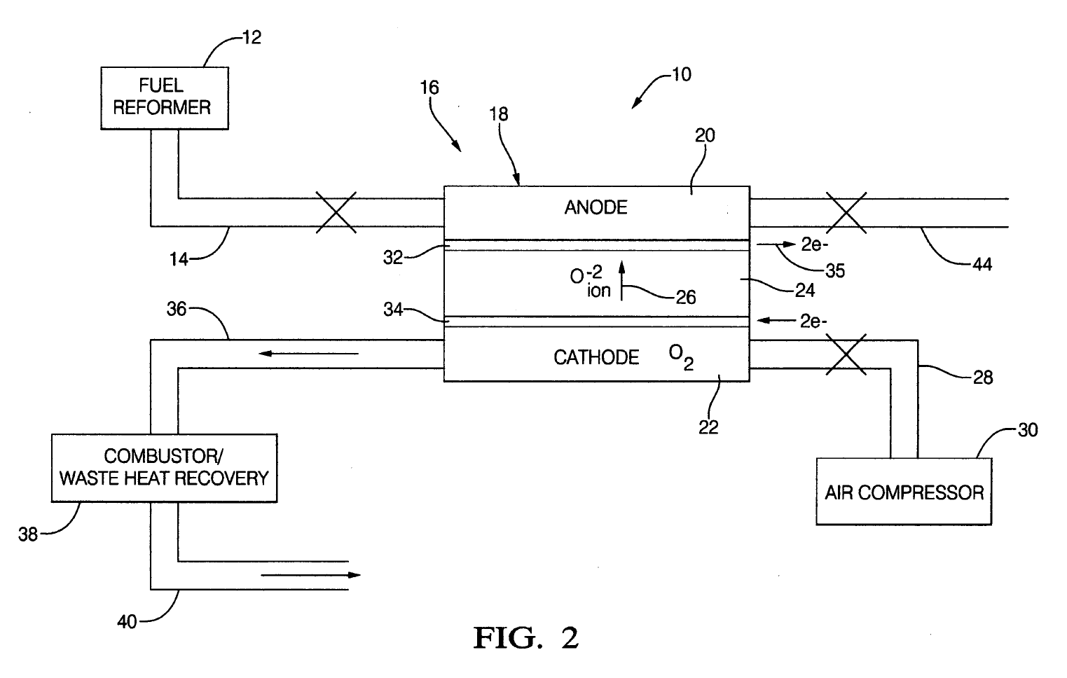

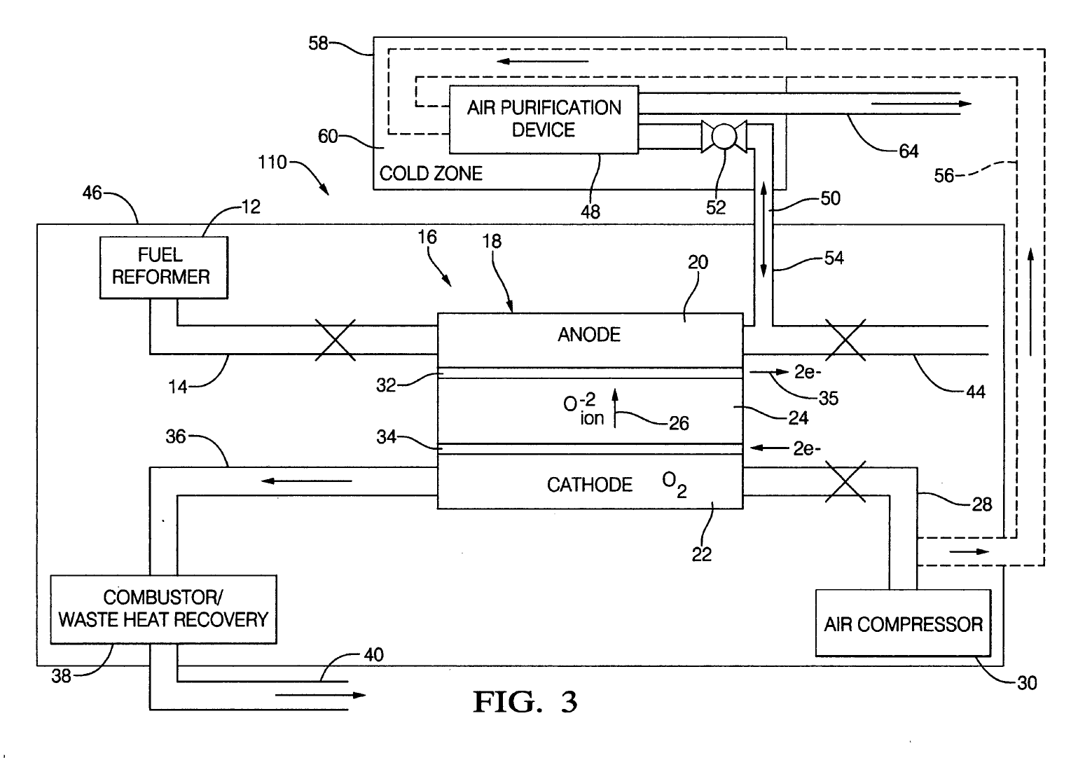

FIG. 3 is a block diagram schematically illustrating the structure and method of improved shut down of a fuel cell system 110 for cooling oxygen sensitive components and exemplary gas flow therein during cool down in accordance with the invention where the same reference numerals are used for the same elements as in FIGS. 1-2. The system and method for cooling oxygen sensitive components is described herein in connection with a solid oxide fuel cell system. However, it is to be understood that the described system and method can be employed with any type of fuel cell system such as a solid oxide fuel cell, proton exchange membrane (PEM) fuel cell, phosphoric acid fuel cell, molten carbonate fuel cell, and the like, and can be employed for cooling other or additional oxygen sensitive heated components of a combined fuel processor and stack assembly such as catalytically-based fuel reformers, chemical traps (such as desulfurization devices), among others, such that the additional or other oxygen sensitive heated components are cooled by a flow of the nitrogen gas stream from the air purification device. System 110 includes fuel reformer 12 for supplying an anode fuel stream 14 comprising CO, H₂, N₂, etc., to the SOFC stack 16. For purposes of simplification, stack 16 is represented as a single fuel cell 18 comprising anode 20 and cathode 22 having electrolyte 24 disposed between the electrodes 20, 22 and having anode catalyst/electrolyte interface 32 and cathode/electrolyte interface 34. Typically, multiple fuel cells 18 are stacked in series with the anode of one cell being electrically connected to the cathode of the next cell. The fuel cells may also be stack in parallel. Any number of fuel cells may be employed, with 30-60 cells being typical for transportation applications and 10-120 cells being typical for certain stationary applications such as residential power, back-up or emergency power, or remote-site or off-grid electrical generation. Fuel from the anode fuel stream 14 at the anode catalyst/electrolyte interface 32 forms cations that react with oxygen ions diffusing through the solid oxide electrolyte 24 to the anode 20. The oxygen-containing gas 28 (typically air) supplied to the cathode layer 22 converts oxygen molecules into oxygen ions at the cathode/electrolyte interface 34. The oxygen ions formed at the cathode 22 diffuse, combining with the cations to generate a usable electric current 35 and an oxygen depleted air stream 36 that is removed from the cell 18 such as through a combustor or a waste energy recovery assembly 38, and exits the system 10 as effluent stream 40. The combustor or waster heat recovery assembly, each indicated by reference numeral 38, may comprise one device or separate flow-coupled devices. Optionally, anode waste stream 44 may be directed through fuel reformer 12 for exhaust gas recycle or through combustor 38 for waste heat recovery.

The fuel reformer 12, SOFC stack 16, air compressor 30, and combustor 38 are located within a thermal management enclosure 46. Optionally, fuel reformer 12 is located within the thermal management enclosure 46 yet is thermally isolated from the fuel cell stack 16.

System 110 includes an air purification or air separation device 48 for preparing a stream 50 of nitrogen and including means 52 for regulating the flow of nitrogen enriched stream 50. Air purification device 48 may alternately be termed an air separation or nitrogen enrichment device. Block 48 represents an air purification device such as a membrane separator, molecular sieve filter, pressure-swing adsorber, chromatographic separation device, paramagnetic separator, cryogenic separator, or a combination thereof During cool down, the anode 20 is isolated from the fuel source/fuel reformer 12 and from the anode exhaust (through isolation means such as a valve) but connected to the air purification device/nitrogen enrichment device 48 through conduit 54. The air purification/nitrogen enrichment device 48 is normally not in fluid communication with the stack 16 while the stack is in start-up or operating mode; however, the air purification/nitrogen enrichment device 48 could be operated in these modes to serve as a means for cooling the stack 16 with inert gas or as a means for purging a cool stack prior to start-up). Prior to entering the stack 16 (or part to be cooled), make-up air 56 is directed through the air purification/nitrogen enrichment device 48 and treated therein to separate oxygen from the make up air 56 providing a supply of purified N₂ 50 to the device to be cooled. Because the volume of open space in the anode and cathode side may be different, the volume of nitrogen stream 50 is not necessarily equal to the volume of air pulled back into the cathode via reverse flow from combustor during cool down. What is important is that the isostatic (isobaric) condition of the stack is maintained. Flow is self-regulating to maintain atmospheric pressure in both sides. Flow into the anode 20 is limited to N₂ (or optionally N₂ and Ar). In this way, the pressure within the cooling cell or cells 18 is balanced thereby preventing damage associated with pressure differences between the anode 20 and cathode 22, such as cracking of the electrolyte 24, while also preventing oxidation damage to the anode 20.

By providing air purification/nitrogen enrichment device 48 in the flow path of the make-up air 56, purified nitrogen 50 is introduced into the SOFC anode 20 or heated device, as opposed to air. In this way, the device, whether an SOFC anode, or other heated components of a combined fuel processor and stack assembly, or other parts, is protected from the detrimental effects of O₂ in air. The nitrogen enrichment device 48 may require low operating temperatures to be effective and so is preferably located outside of any thermal enclosures, with the product gas delivered to the device to be cooled typically contained in a thermal enclosure via suitable conduits or tubing 54. In the embodiment of FIG. 3, air purification/nitrogen enrichment device 48 is located outside of thermal enclosure 46 within a cold zone enclosure 58 providing a cold zone 60. The cold zone 60 comprises, for example, a normal ambient temperature in the range of from about −20° F. to about 120° F. Nitrogen fed to the anode may optionally be preheated such as by passing the nitrogen stream through a suitable length of conduit 54 in the thermal enclosure 46 so as to be close to anode temperature when entering the anode chamber. Conduit 54 comprises a sealed passage for connecting the air purification device to the anode including a means for closing this passage when not in use.

Air purification/nitrogen enrichment device 48 may comprise any device suitable for separating O₂ from air thereby providing a purified stream of N₂ or N₂ and Ar. The volume of N₂, Ar will be less than about 50% of the total stack volume (stack volume typically being from about 1 to about 10 liters). The air purification device 48 is selected in accordance with the requirements of a given system. Generally, the air purification device is selected to supply a gas with less than about 1 part per million O₂, a flow rate that is very low, such as a flow rate in the range of about 0.01 to about 100 ml/min, most typically from about 0.05 to about 5 ml/min, and a supply pressure that is close to atmospheric. Examples of suitable air purification devices as represented generally by reference numeral 48 include, but are not limited to, membrane separators, molecular sieve filters, pressure-swing adsorbers, chromatographic separation devices, paramagnetic separators, cryogenic separators or a combination thereof.

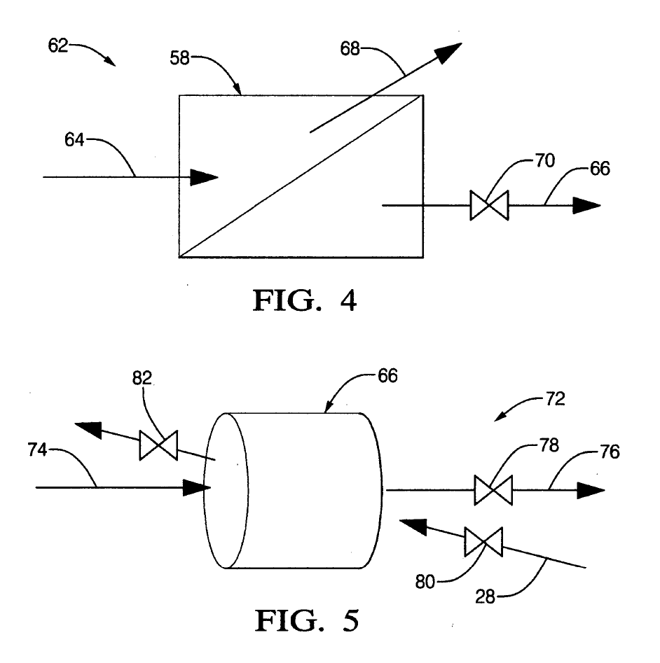

In FIG. 4, one possible embodiment for the oxygen purification/nitrogen enrichment device 48 is shown in the form of membrane separator 62. Membrane separator 62 includes an inlet for receiving a supply of compressed air 64 such as from air compressor 30. Within membrane separator 62, the compressed air 64 is separated providing N₂, and optionally Ar, stream 66 and oxygen enriched air stream 68. The device 62 includes a valve means 70 for regulating the flow of N₂ stream 66. The membrane is selected so that only N₂ can pass through the membrane, so that the effluent is in two streams—a low flow rate of N₂ and the majority of the gas (in the form of oxygen enriched air stream 68) is exhausted. Suitable membranes include polymer, ceramic, or metallic based, or combinations of thereof.

Turning to FIG. 5, another embodiment of the oxygen purification/nitrogen enrichment device 48 comprises a molecular sieve 72. Molecular sieve 72 includes an inlet for receiving a supply of compressed air 74 and an outlet for discharging a stream 76 of N₂ (and optionally Ar). The molecular sieve includes means for selectively retaining O₂, while allowing N₂ (and Ar) to pass through. Valve means 78 regulates the flow of N₂ (and optionally Ar) stream 76. The molecular sieve 72 has a volume of sieve material sufficient to process enough air to provide the required volume of N₂, with some safety margin. Typical molecular sieve materials include, but are not limited to, zeolites and commercially available materials such as silica gel, activated alumina, carbon-based sieve materials, molecular sieve 3A, molecular sieve 4A, molecular sieve 5A, molecular sieve 13X, HayeSep® DB, HayeSep® D, available from Valco Instruments Co. Inc., or other materials capable of selectively retaining oxygen or nitrogen in favor of the other. Volumes of sieve material can be from 1 to 100 times the amount of N₂ required to be produced in a single cool-down cycle, depending on the capacity of the material selected.

Periodically, the nitrogen enrichment devices may need to be back-flushed or regenerated. By providing a suitable configuration of valves and tubing, supply air can be provided to the air separation device to accomplish back-flushing, as required, to be conducted either during shut-down or during normal operation of the part. Usually, when the parts to be cooled in accordance with the present method (e.g., fuel cells) are operational and are not requiring purified N₂ (not in the process of cool down), the nitrogen purification device can be regenerated. For example, as shown in FIG. 5, during stack operation, the system may be back flushed using a supply of air 28, such as from air compressor 30, regulated via valve means 80 and vented via back flush vent 82 to remove adsorbed O₂. The back flush air can optionally be passed through the heated enclosure, so as to provide heated air to aid in the back flush or regeneration process. Optionally, stream 28 can be replaced by reformate stream 14 to accomplish the regeneration, either hot or cooled prior to entering device 48.

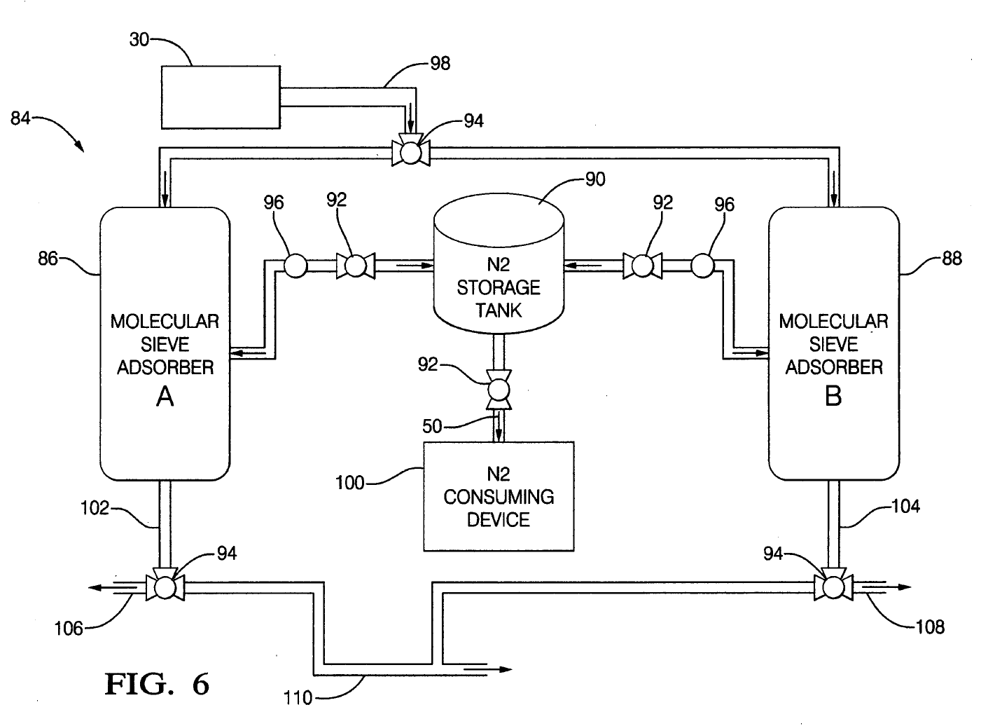

Turning to FIG. 6, another embodiment of the oxygen purification/nitrogen enrichment device 48 is shown comprising a pressure-swing adsorption device 84. Pressure swing adsorber 84 includes a first molecular sieve adsorber 86, a second molecular sieve adsorber 88, and a nitrogen storage tank 90. Multiple two way on/off valves 92, three way (off, flow 1, flow 2) valves 94, and pressure reducing orifices 96 are disposed to control volumetric flow rates and flow directions through valve open times and sizing of orifices. In operation, high pressure air 98, such as from air compressor 30, is directed to the first molecular sieve adsorber 86 and the second molecular sieve adsorber 88 is flushed with nitrogen from the nitrogen storage tank 90. Nitrogen from the first molecular sieve 86 is released to the nitrogen storage tank 90 and high pressure air 98 is directed to the second molecular sieve adsorber 88. The first molecular sieve adsorber 86 is flushed with nitrogen from storage tank 90. Nitrogen is released from the second molecular sieve adsorber 88 to the storage tank 90. Nitrogen stream 50 is fed to the nitrogen consuming device 100 such as SOFC anode 20. Enriched air effluent streams 102, 104 exit as nitrogen flush purge streams 106, 108, or as vented stream 110 which is optionally directed to an oxygen enriched air storage or utilization device.

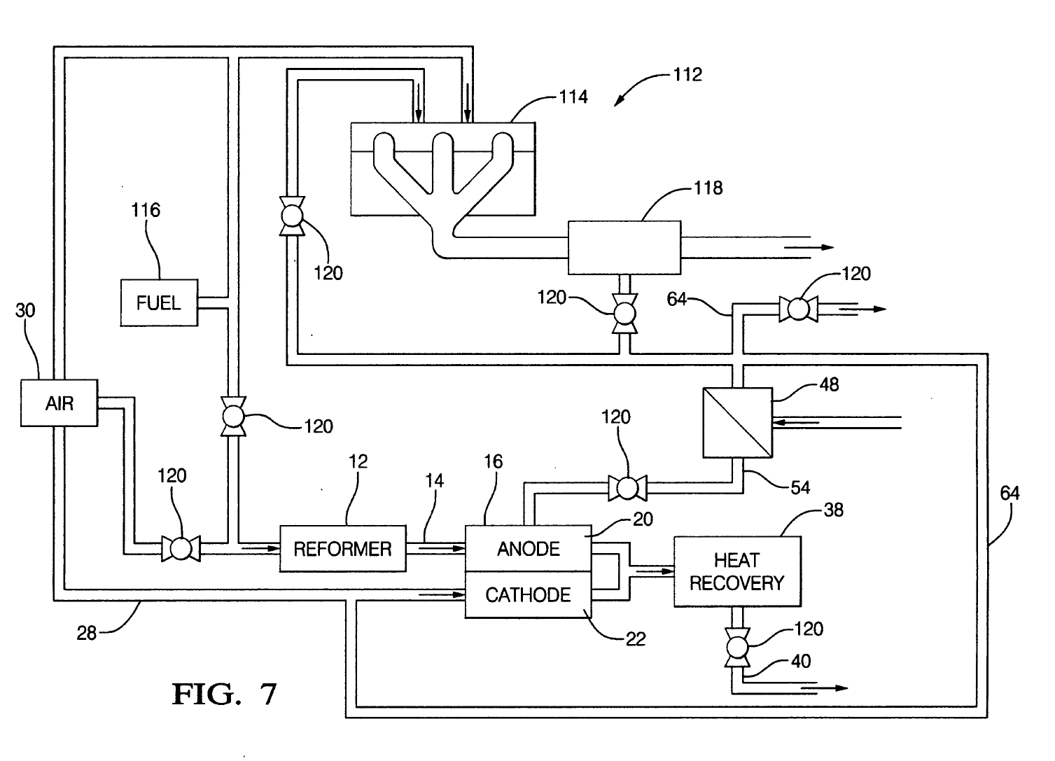

Secondary products produced from the air purification/nitrogen enrichment devices can be used in the fuel cell system or in components of a power generation system. FIG. 7 is a block diagram schematically illustrating a fuel cell power generation system 112 that is a preferred embodiment of the invention. Power generation system 112 includes an engine 114 having an inlet and an exhaust, a fuel supply 116, an exhaust treatment device 118 disposed in fluid communication with the engine exhaust, such as a catalytic converter, fuel cell stack 16, fuel reformer 12, air purification device 48 disposed in fluid communication with the engine 114 and optional exhaust treatment device to supply a supply of oxygen enriched air produced by the air purification device 48 to one or both of the engine 114 and catalytic converter 118, air compressor 30, and heat recovery device 38, along with associated piping (shown as solid lines representing exemplary gas flow patterns in FIG. 7) and gas flow control means such as two way valves 120 for controlling the gas flow to the various system components. For example, oxygen enriched air 64 produced by the air purification/nitrogen enrichment device 48, which would typically be discharged, can be supplied to oxygen consuming components, such as engine 114, enhancing performance while reducing volumetric flow rates, compressor usage, and in general reducing parasitic energy consumption. Under normal operation, when purified nitrogen is not required, oxygen enriched air 64 can be supplied to components such as the fuel cell cathode 22, fuel reformer inlet 12, combustion catalyst 38, engine exhaust catalyst 118, or engine 114, such as, but not limited to, an internal combustion engine, spark ignition engine, direct ignition engine, etc.

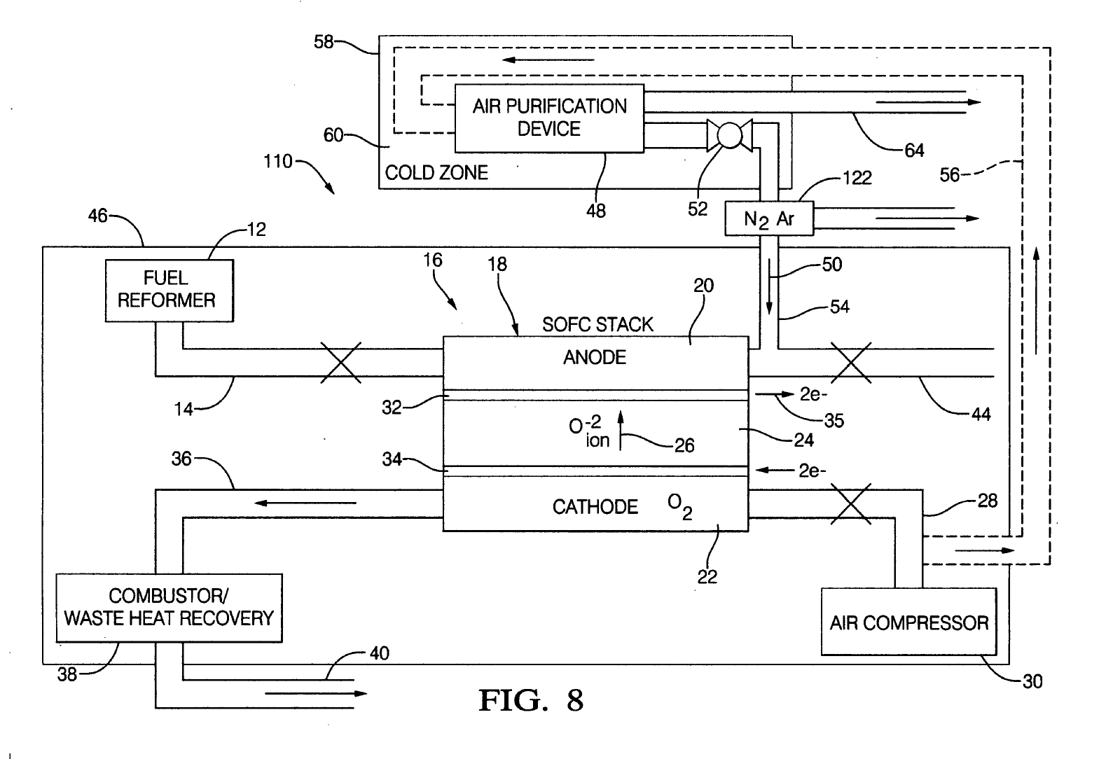

FIG. 8 is a block diagram illustrating another embodiment of the invention. While nitrogen is supplied in very pure form to the parts to be cooled, some residual oxygen may be present as noted hereinabove. In this situation, an oxygen removal device may be employed, such as, for example, that disclosed in U.S. Pat. No. 6,744,235, issued Jun. 1, 2004, entitled “Oxygen Isolation and Collection for Anode Protection in a Solid-Oxide Fuel Cell Stack” which is hereby incorporated by reference herein in its entirety, which discloses use of a nickel-based oxygen getter. FIG. 8 shows oxygen removal device 122 disposed between the air purification device 48 and the anode 20 in the flow path of conduit 50. In the present system, the mass of oxygen-getter required is significantly reduced due to the much smaller mass of oxygen required to be removed. Suitable oxygen removal devices include, but are not limited to, nickel-based oxygen getters, copper, iron, manganese, silver, or combinations thereof, among others, disposed to react with or adsorb oxygen. The oxygen removal device 122 can be regenerated by passing anode exhaust stream 44 or reformate stream 14 through device 122.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A fuel cell system for cooling oxygen sensitive components comprising:
a fuel cell stack comprising at least one fuel cell comprising an anode, a cathode, and an electrolyte disposed between the anode and cathode;
a fuel reformer disposed in fluid communication with the fuel cell stack for supplying a flow of fuel to the anode;
an air supply disposed in fluid communication with the fuel cell stack for supplying a flow of air to the cathode; and
an air purification device for preparing a nitrogen gas stream, the air purification device having an inlet for receiving a flow of air and an outlet in fluid communication with the fuel cell stack anode for discharging the nitrogen gas stream; a means for supplying a flow of the nitrogen gas stream to the anode during fuel cell cool down and optionally, during fuel cell shut down; and an outlet for discharging a flow of oxygen enriched air;
wherein the flow of the nitrogen gas stream is sufficient to balance pressure within the fuel cell cathode and anode during cool down.

2. The system of claim 1, wherein the air purification device is a device suitable for preparing a nitrogen gas stream having an oxygen content of less than about 1 part per million oxygen.

3. The system of claim 1, wherein the air purification device is a device providing a nitrogen gas stream flow rate in the range of about 0.01 to about 100 ml/min.

4. The system of claim 1, wherein the air purification device is a device providing a nitrogen gas stream flow rate in the range of about 0.05 to about 5 ml/min.

5. The system of claim 1, wherein the air purification device is a device providing a supply pressure that is close to atmospheric pressure.

6. The system of claim 1, wherein the air purification device is selected from the group consisting of membrane separators, molecular sieve filters, pressure-swing adsorbers, chromatographic separation devices, paramagnetic separators, cryogenic separators, or a combination thereof.

7. The system of claim 1, wherein the fuel cells comprise solid oxide fuel cells, proton exchange membrane fuel cells, phosphoric acid fuel cells, or molten carbonate fuel cells.

8. The system of claim 1, further comprising:
a thermal enclosure;
wherein the fuel cell stack, fuel reformer, and air supply are disposed within the thermal enclosure and wherein the air purification device is located outside of the thermal enclosure.

9. The system of claim 1, further comprising:
a thermal enclosure;
a cold zone enclosure disposed outside of the thermal enclosure;
wherein the fuel cell stack, fuel reformer, and air supply are disposed within the thermal enclosure; and
wherein the air purification device is located within the cold zone enclosure.

10. The system of claim 1, further comprising:
a waste energy recovery device disposed in fluid communication with the cathode for receiving and treating an oxygen depleted air stream from the cathode; and,
optionally, the waste energy recovery device is further disposed in fluid communication with the anode for receiving and treating an anode waste stream.

11. The system of claim 1, further comprising:
an oxygen removal device disposed in the flow path of the nitrogen gas stream upstream of the anode.

12. The system of claim 11, wherein the oxygen removal device is selected from the group consisting of an oxygen getter containing nickel, copper, iron, manganese, or silver, or a combination thereof, disposed to react with or adsorb oxygen.

13. The system of claim 1, wherein the air purification device is further disposed in fluid communication with additional oxygen sensitive heated components in the system such that the additional oxygen sensitive heated components are cooled by a flow of the nitrogen gas stream from the air purification device.

14. The system of claim 1, further comprising:
an engine having an inlet and an exhaust;
optionally at least one exhaust treatment device disposed in fluid communication with the engine exhaust;
wherein the engine and, if present, the optional at least one exhaust treatment device, are disposed in fluid communication with the air purification device to receive a supply of oxygen enriched air produced by the air purification device.

15. The system of claim 1, wherein one or both of the cathode and fuel reformer are disposed in fluid communication with the air purification device to receive a supply of oxygen enriched air produced by the air purification device.

16. The system of claim 1, further comprising:
means for isolating the anode from the reformer and anode exhaust passage during cool down.

17. A method for cooling oxygen sensitive components in a fuel cell system comprising:
supplying air to an air purification device during cool down of a fuel cell system comprising at least one fuel cell comprising an anode, a cathode, and an electrolyte disposed between the anode and the cathode;
treating the supplied air within the air purification device to produce a nitrogen gas stream and a waste stream comprising oxygen enriched air;
directing the produced nitrogen gas stream through the anode; the anode being in fluid communication with the air purification device;
the flow of nitrogen gas stream being sufficient to balance pressure within the fuel cell cathode and anode during fuel cell cool down.

18. The method of claim 17, further comprising:
directing the nitrogen gas stream through the anode during fuel cell cool down and during fuel cell shut down.

19. The method of claim 17, further comprising:
supplying a flow of fuel to the anode via a fuel reformer disposed in fluid communication with the fuel cell stack;
supplying a flow of air to the cathode via an air supply disposed in fluid communication with the fuel cell stack; and
isolating the anode from the fuel reformer and from the anode exhaust passage during fuel cell cool down.

20. The method of claim 17, wherein the air purification device is selected from the group consisting of membrane separators, molecular sieve filters, pressure-swing adsorbers, chromatographic separation devices, paramagnetic separators, cryogenic separators or a combination thereof

21. The method of claim 17, wherein the fuel cells comprise solid oxide fuel cells, proton exchange membrane fuel cells, phosphoric acid fuel cells, or molten carbonate fuel cells.

22. The method of claim 17, further comprising:
disposing the fuel cell stack, fuel reformer, and air supply within a thermal enclosure and locating the air purification device outside of the thermal enclosure.

23. The method of claim 17, further comprising:
disposing the fuel cell stack, fuel reformer, and air supply within a thermal enclosure; and
disposing the air purification device within a cold zone enclosure located outside of the thermal enclosure.

24. The method of claim 17, further comprising:
directing an oxygen depleted air stream from the cathode through a waste energy recovery device disposed in fluid communication with the cathode and treating the oxygen depleted air stream therein.

25. The method of claim 17, further comprising:
directing an anode waste stream through a waste energy recovery device disposed in fluid communication with the anode and treating the anode waste stream therein.

26. The method of claim 17, further comprising:
regenerating the air purification device by passing a flow of supply air through the air purification device; and
optionally, heating the flow of supply air so as to provide heated air to aid in the regeneration process.

27. The method of claim 17, further comprising:
during intervals when the fuel cell is operating, supplying the waste stream comprising oxygen enriched air from the air purification device to the fuel cell cathode, a fuel reformer air inlet, a combustion catalyst, an exhaust catalyst, an engine, an internal combustion engine, a spark ignition engine, a direct ignition engine, or a combination thereof.

28. The method of claim 17, further comprising:
removing residual oxygen from the flow of nitrogen gas stream produced by the air purification device via an oxygen removal device disposed in a flow path of the nitrogen gas stream upstream of the anode.

29. The method of claim 28, wherein the oxygen removal device is selected from the group consisting of an oxygen getter containing nickel, copper, iron, manganese, or silver, or a combination thereof, disposed to react with or adsorb oxygen.

30. The method of claim 17, further comprising:
treating supplied air within the air purification device to produce a nitrogen gas stream having an oxygen content of less than about 1 part per million of oxygen.

31. The method of claim 17, further comprising:
treating supplied air within the air purification device to produce nitrogen gas stream having a flow rate in the range of about 0.01 to about 100 milliliters per minute.

32. The method of claim 17, further comprising:
treating supplied air within the air purification device to produce a nitrogen gas stream having a flow rate in the range of about 0.05 to about 5 milliliters per minute.

33. The method of claim 17, further comprising:
treating supplied air within the air purification device to produce a nitrogen gas stream having a supply pressure that is close to atmospheric pressure.

34. The method of claim 17, further comprising:
in a system further comprising additional oxygen sensitive heated components, cooling the additional components in the system with a flow of nitrogen gas produced from the air purification device.

35. The method of claim 17, further comprising:
cooling the fuel cell stack during start up or operating mode with said nitrogen gas stream; and
optionally, purging the fuel cell stack when cool with said nitrogen gas stream prior to start up.

36. The method of claim 17, further comprising:
preheating the nitrogen gas stream prior to directing to the anode.
